(19) United States
(12) Patent Application Publication
(10) Pub. No.: US 2020/0189270 A1
(43) Pub. Date: Jun. 18, 2020

(54) Inkjet Recording Device and Inkjet Recording Device Control Method

(71) Applicant: Hitachi Industrial Equipment Systems Co., Ltd., Chiyoda-ku, Tokyo (JP)

(72) Inventors: Keisuke OKAWA, Tokyo (JP); Takashi KAWANO, Tokyo (JP); An KYU, Tokyo (JP)

(21) Appl. No.: 16/323,425

(22) PCT Filed: Aug. 21, 2017
(86) PCT No.: PCT/JP2017/029730

§ 371 Date: Feb. 5, 2019

(30) Foreign Application Priority Data
Aug. 22, 2016 (JP) 2016-161622

(51) Int. Cl. B41J 2/045

(52) U.S. Cl. CPC B41J 2/04573; B41J 2/04586

(57) ABSTRACT

Provided is an inkjet recording device control method including: a printing object detection step of detecting a printing object; a charge control signal transmission step of transmitting signals for controlling charges of a plurality of nozzles at a timing when the printing object is detected in the printing object detection step and signals are received from all of a plurality of processing units; and a printing step of controlling the plurality of nozzles and performing printing on the basis of the signals for controlling the charges that have been transmitted in the charge signal transmission step.

### TECHNICAL FIELD

The present invention relates to an inkjet recording device and an inkjet recording device control method.

### BACKGROUND ART

As a background for the present invention, there is JP 2010-228402 A. This publication states that “an inkjet recording device capable of eliminating a deviation in a writing position between nozzles by allowing a writing time to be set for each nozzle”.

### CITATION LIST

### Patent Document

Patent Document 1: JP 2010-228402 A

### SUMMARY OF THE INVENTION

### Problems to be Solved by the Invention

An inkjet recording device is often used in production lines in factories where food and beverages are produced, because they are used to print an expiration date, a date of manufacture, a serial number or the like. In the food and beverage field, there are many high-speed production lines, and demand for inkjet recording devices to print larger characters and logo marks compared to conventional fonts is increasing. In the case of an inkjet recording device with only one nozzle, there is a limit to a size of ink particle that can be deflected. Therefore, it is often difficult in terms of product characteristics to print for a use such as printing characters and logo marks larger than the conventional ones.

On the other hand, in the case of an inkjet recording device constituted by a plurality of nozzles, the size of the ink particle that can be deflected is larger than that in the case of the signal nozzle, which is an advantage of being able to cope with the aforementioned use intention. There is a demerit that a processing speed of information about a printing dot is limited when a single MPU controls printing control of each nozzle in common as the method described in Patent Document 1.

On the other hand, in the case of preforming control with a plurality of MPUs, each MPU operates depending on an independent control clock, so there is a problem that a deviation in a timing of starting the printing is incurred for each nozzle.

### Solutions to Problems

In order to solve the aforementioned problem, for example, configurations described in the claims are adopted.

The present invention includes a plurality of means for solving the above-mentioned problem. As an example of the present invention, an inkjet recording device control method includes: a printing object detection step of detecting a printing object; a charge control signal transmission step of transmitting signals for controlling charges of a plurality of nozzles at a timing when the printing object is detected in the printing object detection step and signals are received from all of a plurality of processing units; and a printing step of controlling the plurality of nozzles and performing a printing based on the signals for controlling the charges that have been transmitted in the charge signal transmission step.

### Effects of the Invention

According to the present invention, it is possible to provide a method of controlling an inkjet recording device and an inkjet recording device control method that realize high-precision printing control.

### BRIEF DESCRIPTION OF THE DRAWINGS

FIG. 1 is a diagram illustrating an overall configuration of an inkjet recording device according to an embodiment.

FIG. 2 is a diagram illustrating an internal processing timing of a nozzle control MPU of the inkjet recording device according to the embodiment.

FIG. 3 is a diagram illustrating a control configuration of an inkjet recording device according to the embodiment.

FIG. 4 illustrates a screen example of a setting item of synchronization control between nozzles.

FIG. 5 illustrates an example of a printing result by a difference in an output timing of a charge voltage for each nozzle.

FIG. 6 illustrates a screen example of the setting item and an adjustment value for the synchronization control between the nozzles.

FIG. 7 illustrates a screen example of the setting item of the synchronization control between the nozzles and an excitation frequency.

FIG. 8 illustrates a screen example of the setting item of the synchronization control between the nozzles and a printing pitch.

FIG. 9 is a printing control flow.

FIG. 10 illustrates a control configuration of an inkjet recording device according to a modification example.

FIG. 11 illustrates an internal processing timing of each nozzle control MPU of the inkjet recording device according to the modification example.

FIG. 12 is a printing control flow according to the modification example.

### MODE FOR CARRYING OUT THE INVENTION

### First Embodiment

Hereinafter, an embodiment will be described with reference to the drawings.

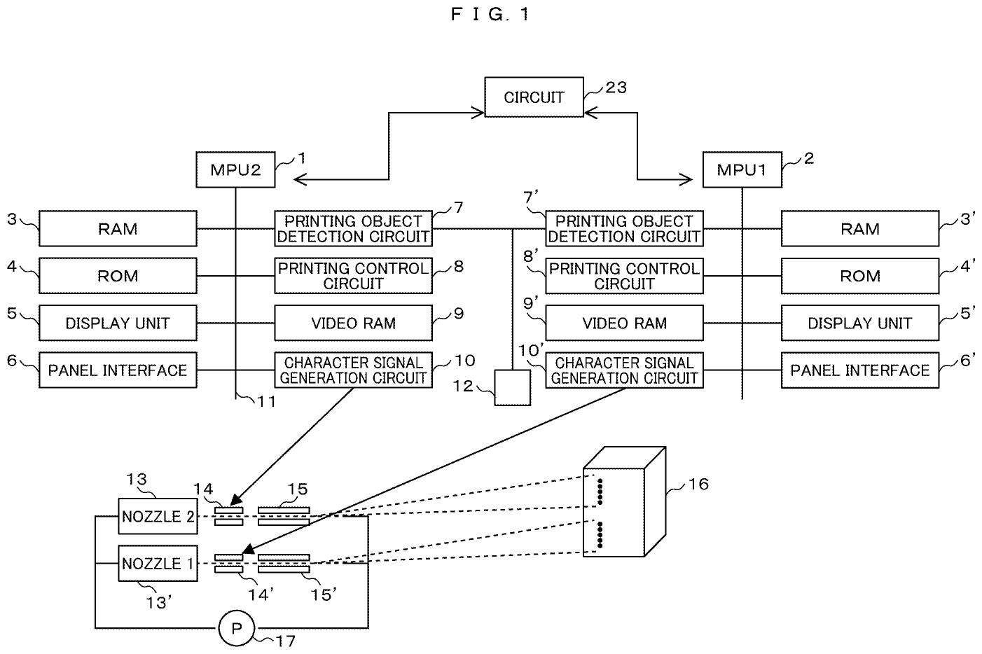

FIG. 1 is an outline view illustrating an overall configuration of an inkjet recording device according to an embodiment.

Reference numerals 1 and 2 are MPUs (micro processing units) for controlling the inkjet recording device, reference numeral 3 is a random access memory (RAM) for temporarily storing data, reference numeral 4 is a read only memory (ROM) for storing a program in advance, reference numeral 5 is a display unit, reference numeral 6 is a panel interface which receives an operation from a panel and to which character information and the like relating to printing are input, reference numeral 7 is a printing object detection circuit, reference numeral 8 is a printing control circuit for controlling a printing operation of the inkjet recording device, reference numeral 9 is a video RAM for storing video data to be charged to an ink particle, and reference numeral 10 is a character signal generation circuit that uses video data as a charge signal. These configurations are communicably connected to each other via a bus 11. In addition, video data for determining an amount of charging to the ink particle based on the character information input to the panel interface 6 is created and stored in the video RAMS 9 and 9′.

Further, reference numeral 12 is a printing object sensor for detecting the printing object 16, reference numeral 13 is a nozzle for printing on the printing object 16, reference numeral 14 is a charge electrode for charging the ink passing through the nozzle 13, reference numeral 15 is a deflection electrode for deflecting the ink passing through the charge electrode 14, and reference numeral 17 is a pump for ejecting the ink from the nozzles 15 and 15′.

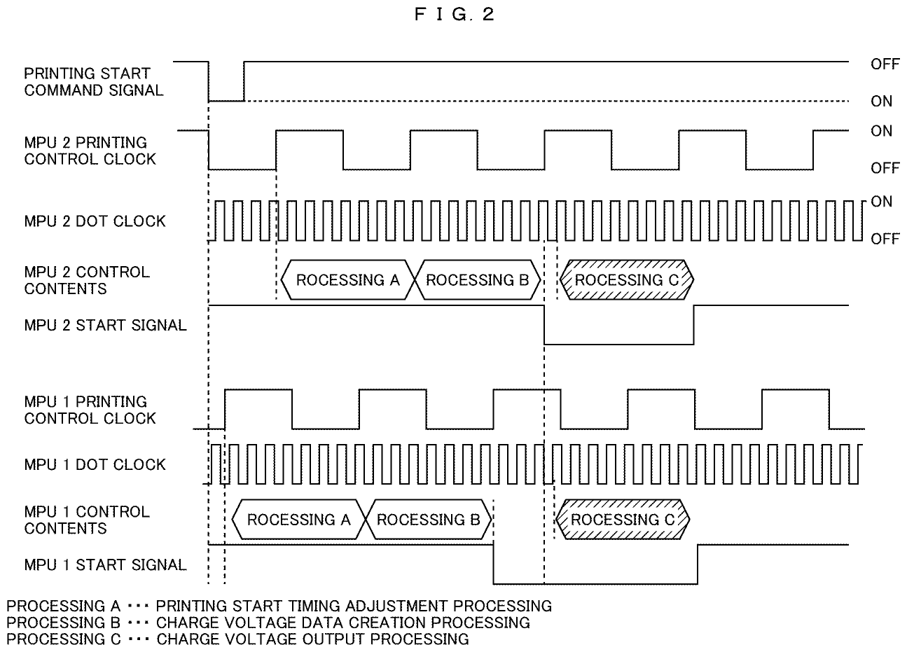

FIGS. 2, 3 and 9 are diagrams describing control contents at the time of printing control.

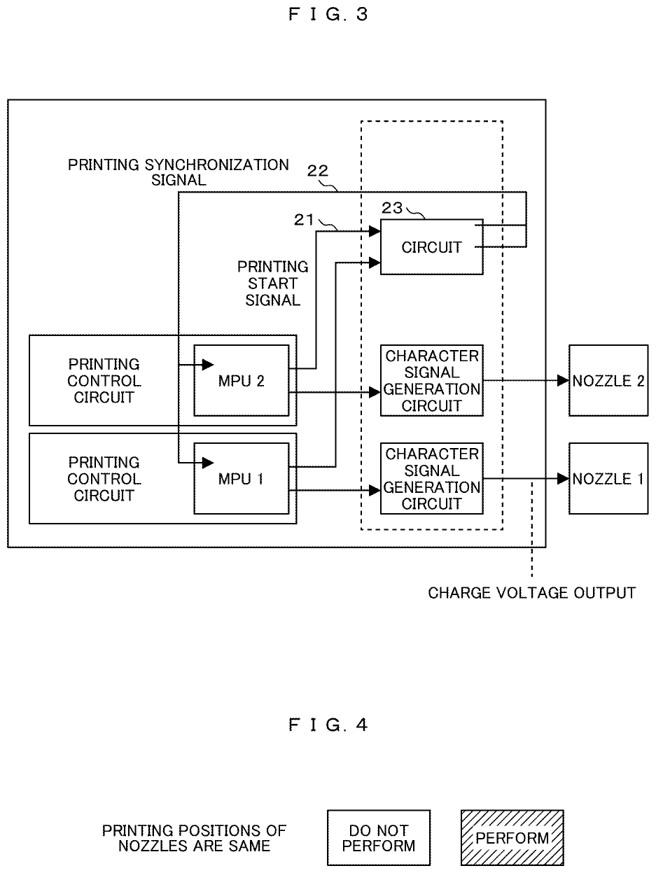

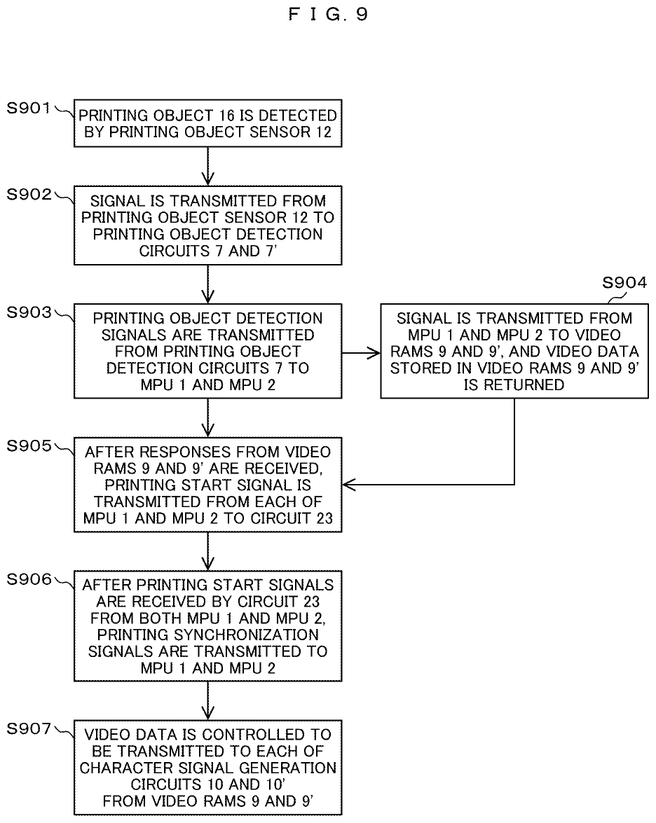

FIG. 3 is a diagram describing a printing control configuration for performing the printing control so that the inkjet recording device according to the embodiment illustrated in FIG. 1 may not cause a deviation in a printing start timing, and FIG. 9 illustrates the printing control flow.

In FIG. 9, when the printing object 16 is detected by the printing object sensor 12 (S901), a signal indicating that the printing object 16 has been detected is transmitted from the printing object sensor 12 to each of the printing object detection circuits 7 and 7′ (S902). When receiving the signal, the printing object detection circuits 7 and 7′ transmit printing object detection signals to the MPUs 1 and 2 respectively (S903). When receiving the printing object detection signals, the MPUs 1 and 2 transmit signals to the video RAMS 9 and 9′. Video data to be charged to ink particles stored in the video RAMS 9 and 9′ in advance is returned to the MPUs 1 and 2 (S904).

When receiving the video data from the video RAMS 9 and 9′, each of the MPUs 1 and 2 transmits a printing start signal to a circuit 23 (S905). Since the printing start signal is first transmitted from the MPU that receives the video data, a timing at which the circuit 23 receives the video data differs for each MPU.

When receiving the printing start signal from both the MPUs 1 and 2, the circuit 23 transmits printing synchronization signals to both the MPUs 1 and 2 (S906). When receiving the printing synchronization signal, the MPUs 1 and 2 control the video RAMS 9 and 9′ so as to transmit the video data from the video RAMS 9 and 9′ to the character signal generation circuits 10 and 10′ respectively (S907). When receiving the signal, the character signal generation circuits 10 and 10′ control the charge electrode 14 to apply charges to the ink particles based on the received signal. The charged ink particles pass through an electric field formed by a positive deflection electrode 15 and a negative deflection electrode 15′ to be deviated and adhere to a printing target. When the printing is performed with a plurality of nozzles, each MPU that performs a printing control generates a charge voltage and charges the ink particles ejected from each nozzle.

In the conventional method of controlling twin nozzles with a plurality of MPUs, after video data is returned by the video RAMS 9 and 9′(S904), the printing control is started by each of the MPUs 1 and 2 without waiting for arrival of a printing start signal from both the MPUs 1 and 2. Thus, there has been a problem in which a deviation occurred in printing start timing. On the other hand, according to the method described with reference to FIG. 9 and the like, the circuit 23 is provided that detects completion of the return of the video data by the video RAMS 9 and 9′ for both the MPUs 1 and 2, and a flow of transmitting a print synchronization signal only after both the video data are received (S906) is provided. Therefore, it is possible to perform the printing without causing a deviation in the printing start timing due to the return and the like of the video data.

Next, an internal processing timing diagram of each nozzle control MPU illustrated in FIG. 2 will be described.

A printing start command signal corresponds to presence or absence of a sensor signal from the printing object sensor 12. An ON time zone indicates that the printing object 16 has been detected by the printing object sensor 12.

Subsequently, after the printing start command signal is turned ON and at the timing when an MPU printing control clock (a printing interval of vertical dots of a printing character) is turned ON for the first time, a processing A (transmission of the video data in the data RAMS 9 and 9′) is started. In FIG. 2, since ON/OFF timings of MPU 1 printing control clock are different from those of MPU 2 printing control clock, the processing A in the MPU 1 is started at a timing earlier than that for the processing A in the MPU 2.

Thereafter, when the processing A (adjustment of the timing until the printing is started) is completed, a processing B (creating a charge voltage data based on the video data stored in the video RAMS 9 and 9′ and transmitting a printing start signal from the MPU 1 and MPU 2 to the circuit 23) is started. Since the processing B is promptly started following the processing A after the processing A is completed, the processing B in the MPU 1 is completed at a timing earlier than that for the processing B in the MPU 2 similarly to the processing A.

Thereafter, after the processing B is completed for both the MPUs and at the timing when the MPU dot clock is turned ON for the first time, a processing C (printing control such as transmitting the printing synchronization signal from the circuit 23 to the MPUs 1 and 2 and outputting the charge voltage) is started. As described above, the processing C is started by waiting for the printing start signal from both the MPU 1 and MPU 2. Therefore, even when a plurality of nozzles is controlled by using a plurality of MPUs, it is possible to perform the printing without causing a deviation in the printing start timing.

Next, a method of setting whether an output timing of a charge voltage for each nozzle is synchronized or asynchronized will be described.

FIG. 4 is a screen example of setting the output timing of the charge voltage for each nozzle. The screen example illustrated in FIG. 4 is displayed on display units 5 and 5′ in FIG. 1 and the like, for example.

On a setting screen of the inkjet recording device, a setting is made as to whether or not to synchronize printing positions of the nozzle, that is, the output timing of the charge voltage. When a setting to perform the synchronization is selected, a synchronization control of each nozzle as described in FIG. 2 and FIG. 3 is performed and the output timing of the charge voltage is matched. On the other hand, when a setting to perform the asynchronization is selected, the synchronization control as described in FIG. 2 and FIG. 3 is not performed, and each nozzle performs the printing control individually.

In this way, the inkjet recording device includes a selection unit that selects whether to perform a synchronous printing control which is a control that transmits a signal relating to a charge control of the plurality of nozzles at the timing when signals are received from all of a plurality of processing units or to perform an asynchronous printing control which is a control that transmits a signal relating to the charge control of the plurality of nozzles at the timing when the signals are received from any one of the plurality of processing units.

The method of controlling the inkjet recording device includes a selection step of selecting any one of: a synchronous control printing which is a first printing method for performing the printing by a charge control signal transmission step and a printing step; and an asynchronous control printing which is a second printing method for performing the printing by an asynchronous charge control signal transmission step of transmitting signals for controlling the charges of the respective nozzles at the timing when a printing object is detected by a printing object detection step and signals are received from any one of a plurality of processing units and an asynchronous printing step of performing the printing by controlling the plurality of nozzles based on the signals for controlling the charges transmitted by the asynchronous charge control signal transmission step.

### Second Embodiment

The present embodiment relates to a method for reducing a deviation in a printing result due to a difference in a collision time of printing dots on a printing target object by upper and lower nozzles when the printing is performed with a plurality of nozzles.

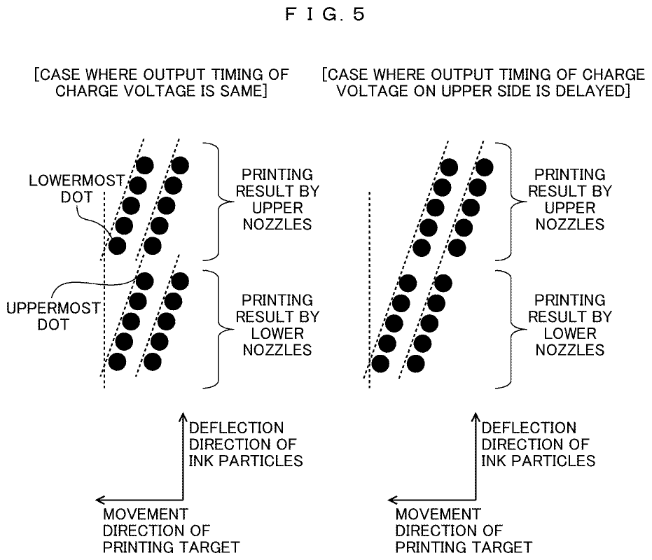

FIG. 5 is an example of the printing when the printing is performed with the plurality of nozzles.

In the case of an inkjet recording device including a plurality of nozzles, there may be a deviation between printing results of the nozzles even if the output timings of the charge voltage between the nozzles are made same. The deviation in the printing results is due to a difference in the collision time of the ink particles of the lowermost dot of an upper nozzle and the uppermost dot of a lower nozzle of printing contents to the printing target object. This is a principled characteristic of the inkjet recording device with the plurality of nozzles.

Since the inkjet recording device starts the printing from the lowermost dot, a difference in the collision time of the ink particles occurs at the uppermost dot and the lowermost dot. Since the printing object moves in the horizontal direction, the difference in the collision time of the ink particles is the difference between the upper nozzle and the lower nozzle in the horizontal direction. In order to improve printing quality, the difference can be resolved by horizontally aligning the lowermost dot of the upper nozzle and the uppermost dot of the lower nozzle of the printing contents. A specific method of the alignment is to delay the output of the charge voltage with respect to the upper nozzle.

The upper nozzle may align positions of the lowermost dot of the upper nozzle and the uppermost dot of the lower nozzle of the printing contents by delaying the output timing of the charge voltage with respect to the lower nozzle. In adjustment of the output timing of the charge voltage in order to improve the printing quality, this function may be performed by setting a time for the output timing where a positional deviation in the horizontal direction assumed in advance may be corrected in a printing control process of a software.

It is possible to reduce a deviation width of a portion which is a boundary between the printing result of the upper nozzle and the printing result of the lower nozzle by setting in advance the output time of the charge voltage for which the deviation time has been considered in the software.

In the present embodiment, when a setting is performed to synchronize the printing position between the nozzles, that is, the output timing of the charge voltage on a setting screen of the inkjet recording device, it is possible to arbitrarily adjust the printing position in addition to the correction processing of the software.

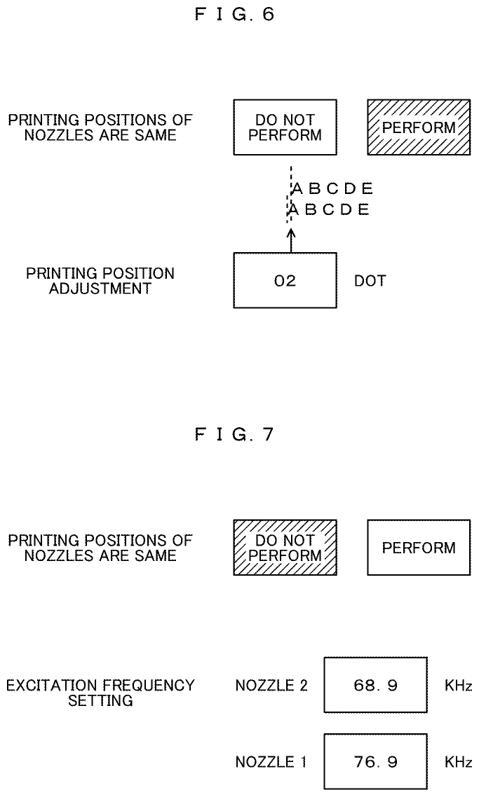

FIG. 6 is a screen example in which a setting for synchronization or asynchronization of the output timing and a setting for an adjustment value of the charge voltage of each nozzle are performed. There is a possibility that a deviation may arise between the lowermost dot of the upper nozzle and the uppermost dot of the lower nozzle in the horizontal direction depending on a variation in components of the nozzle according to a manufacturing accuracy, an environment where the printing is performed or a positional relationship of a printing head and a printing target object in the plurality of nozzles. For this event, a user may arbitrarily set the output timing of the charge voltage by himself, such that the deviation in the printing results arising at a boundary between the nozzles under a use condition of the user may be adjusted by a setting and the printing quality can be improved. The screen example illustrated in FIG. 6 is displayed on the display units 5 and 5′ and the like in FIG. 1, for example.

### Third Embodiment

The present embodiment relates to an inkjet recording device capable of individually setting an excitation frequency which is a generation cycle of ink particles for each nozzle in the control by a plurality of nozzles and a plurality of MPUs.

FIG. 7 is a screen example in which a setting for synchronization or asynchronization of the output timing of the charge voltage of each nozzle and a setting of the excitation frequency for each nozzle are performed. It becomes possible to set the excitation frequency for each nozzle, which makes it possible to widen a range of setting the printing. In addition, it is possible to set a ratio of generated ink particles to be used for the printing and set the excitation frequency for each nozzle, thereby improving a freedom in setting a condition of the printing. In the aforementioned embodiment, since a control in each nozzle is executed based on each MPU, each MPU controls a process of deflecting the excitation frequency and a process of outputting the charge voltage respectively.

### Fourth Embodiment

The present embodiment relates to an inkjet recording device in which a printing at a different line pitch may be realized for each nozzle.

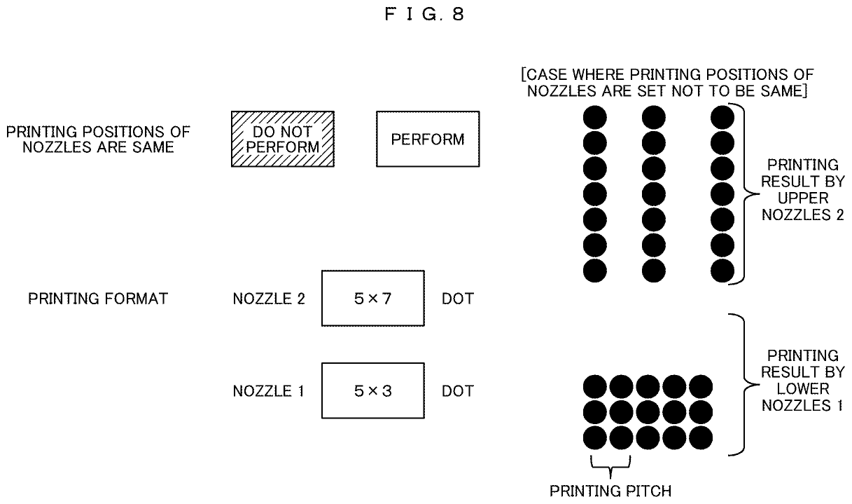

FIG. 8 is a screen example of a setting for synchronization or asynchronization of an output timing of a charge voltage of each nozzle and a setting for a printing pitch of each nozzle. In order to realize a printing at different pitches, a different printing control clock is required in an MPU that controls each nozzle. In a case in which a printing of vertical 7 dots on the upper nozzle side and vertical 3 dots on the lower nozzle side is performed, printing control clocks in each MPU controlling each nozzle are different from each other. It is possible to realize the printing at different printing pitches by performing a printing control individually based on the control clock of each MPU. Therefore, it is possible to switch between a synchronous control and an individual control, such that it is possible to realize the printing at different line pitches in a single inkjet recording device.

### Fifth Embodiment

In the present embodiment, a modification of the control configuration of the first embodiment illustrated in FIGS. 2, 3, and 9 will be described.

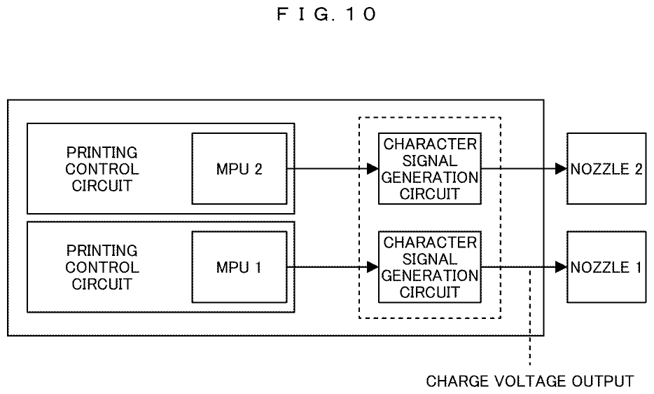

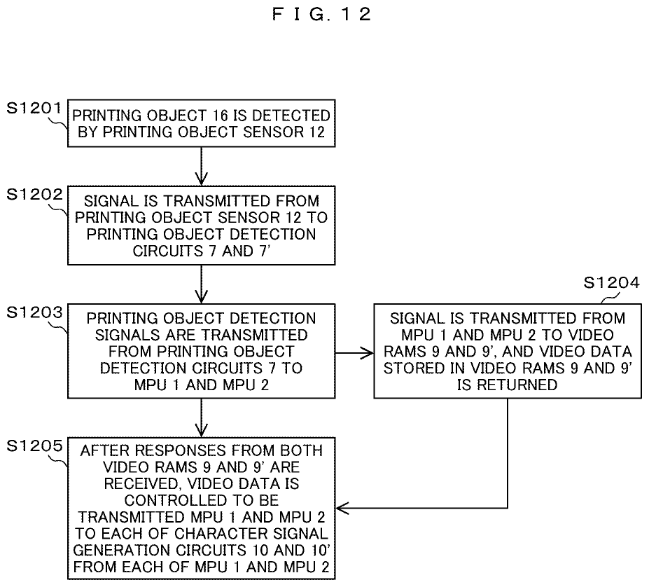

FIG. 10 is a drawing illustrating a control configuration of an inkjet recording device according to a modification, and FIG. 12 is a printing control flowchart according to the modification.

Since a general flow of control is the same as the flow illustrated in FIG. 9, only parts different from FIG. 9 will be described in the present embodiment.

The MPUs 1 and 2 to which video data from the video RAMS 9 and 9′ have been returned in S1204 control the video RAMS 9 and 9′ so as to transmit the video data to the character signal generation circuits 10 and 10′ (S1205).

Thereafter, as in FIG. 9, the character signal generation circuits 10 and 10′ that received the signal control the charge electrode 14 to apply charges to the ink particles, based on the received signal. The charged ink particles pass through an electric field formed by a positive deflection electrode 15 and a negative deflection electrode 15′ to be deflected and adhere to a printing target. When the printing is performed with a plurality of nozzles, each MPU that performs a printing control generates a charge voltage and charges the ink particles ejected from each nozzle.

By directly transmitting the signal from the MPUs 1 and 2 to the character signal generation circuits 10 and 10′ without transmitting a printing start signal, a printing synchronization signal or the like to the circuit 23 and the like after receiving the video data as in the fifth embodiment, it is possible to further shorten a time to be taken before the printing. Further, as in the first embodiment, the signal transmission from the MPUs 1 and 2 to the character signal generation circuits 10 and 10′ is performed after the signal from the video RAMS 9 and 9′ is received. Therefore, there is an effect that there is no deviation in a printing timing due to the plural MPUs.

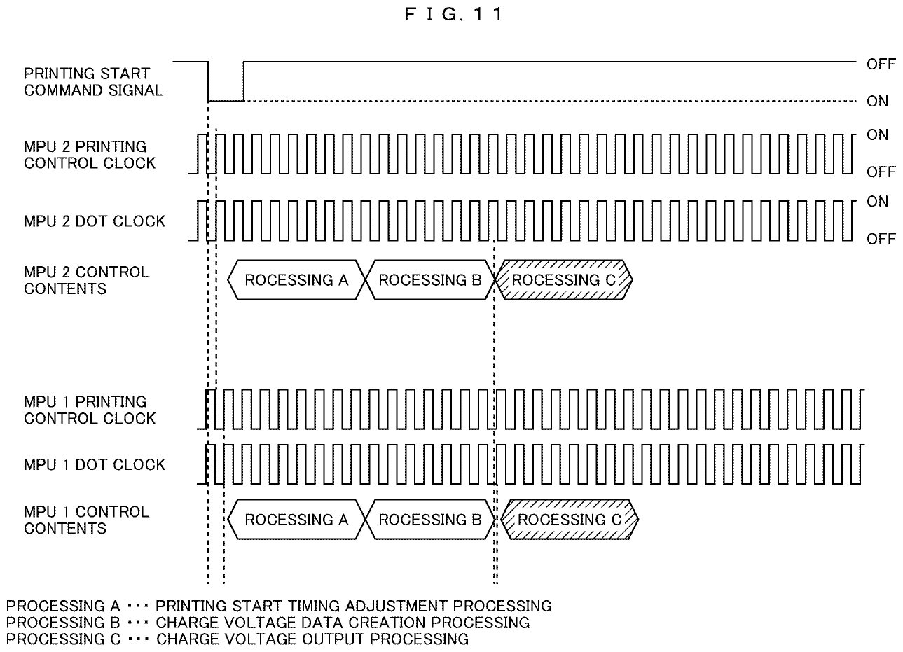

Next, an internal processing timing diagram of each nozzle control MPU illustrated in FIG. 11 will be described.

A printing start command signal corresponds to presence or absence of a sensor signal from a printing object sensor 12. An ON time zone indicates that the printing object 16 has been detected by the printing object sensor 12.

Subsequently, after the printing start command signal is turned ON and at the timing when an MPU printing control clock (a printing interval of vertical dots of a printing character) is turned ON for the first time, a processing A (adjustment of a timing until the printing starts) is started. In FIG. 11, since an ON/OFF timing of an MPU 1 printing control clock is different from that of an MPU 2 printing control clock, the processing A in the MPU 2 is started at a timing earlier than that for the processing A in the MPU 1.

Thereafter, when the processing A (transmission of a signal indicating that a printing object has been detected to the MPUs 1 and 2) is completed, a processing B (creation of a charge voltage data of the video data stored in the video RAMS 9 and 9′) is started. Since the processing B is promptly started following the processing A after the processing A is completed, the processing B in the MPU 1 is completed at a timing earlier than that for the processing B in the MPU 2 similarly to the processing A.

Thereafter, after the processing B is completed for both the MPUs and at the timing when the MPU dot clock is turned ON for the first time, a processing C (printing control such as transmitting the signal from the MPUs 1 and 2 to the character signal generation circuits 10 and 10′ and outputting the charge voltage) is started. As described above, the processing C is started by waiting for the printing start signal from both the MPU 1 and MPU 2. Therefore, even when a plurality of nozzles is controlled by using a plurality of MPUs, it is possible to perform the printing without causing a deviation in the printing start timing.

However, the present invention is not limited to the aforementioned embodiments, but includes various variations. For example, the aforementioned embodiments have been described in detail to explain the present invention in such a way as to understand the invention easily, and are not necessarily limited to those having all the configurations described above. Further, it is possible to substitute a part of a configuration of an embodiment with a configuration of another embodiment, and it is possible to add a configuration of another embodiment to a configuration of an embodiment. Further, it is possible to apply addition, deletion, and replacement of other configuration to a part of the configuration of each embodiment.

In addition, each of the aforementioned configurations, functions, processing units, processing means, and the like may be implemented in hardware by designing some or all of them in, for example, an integration circuit. In addition, the aforementioned configurations, functions, and the like may be implemented in software using a processor interpreting and executing a program that implements each function. Information such as a program, a table, and a file that implements each function can be stored in a recording device such as a memory, a hard disk, or a solid state drive (SSD), or a recording medium such as an IC card, an SD card, or a DVD.

Further, control lines and information lines considered to be necessary for description are indicated, and not necessarily all of the control lines and the information lines on the product are indicated. In practice, it may be considered that almost all configurations are interconnected.

### REFERENCE SIGNS LIST

1: Micro processing unit (MPU) 2
2: Micro processing unit (MPU) 1
3: Random access memory (RAM)
4: Read only memory (ROM)
5: Display unit
6: Panel interface
7: Printing object detection circuit
8: Printing control circuit
9: Video RAM
10: Character signal generation circuit
11: Bus
12: Printing object sensor
13: Printing nozzle
14: Charge electrode
15: Deflection electrode
16: Printing object
21: Printing start signal
22: Printing synchronization signal
23: Circuit

1. An inkjet recording device control method comprising:
a printing object detection step of detecting a printing object;
a charge control signal transmission step of transmitting signals for controlling charges of a plurality of nozzles at a timing when the printing object is detected in the printing object detection step and signals are received from all of a plurality of processing units; and
a printing step of controlling the plurality of nozzles and performing printing based on the signals for controlling the charges that have been transmitted in the charge control signal transmission step.

2. The inkjet recording device control method according to claim 1, further comprising a selection step of selecting any one of: a synchronous control printing that is a first printing method for performing the printing by the charge control signal transmission step and the printing step; and an asynchronous control printing that is a second printing method for performing the printing by an asynchronous charge control signal transmission step of transmitting the signals for controlling the charges of the respective nozzles at a timing when the printing object is detected by the printing object detection step and the signals are received from any one of the plurality of processing units and an asynchronous printing step of performing the printing by controlling the plurality of nozzles based on the signals for controlling the charges transmitted by the asynchronous charge control signal transmission step.

3. An inkjet recording device comprising:
a printing object detection unit that detects a printing object;
a charge control signal transmission unit that transmits signals for controlling charges of a plurality of nozzles at a timing when signals transmitted from all of a plurality of processing units are received, the plurality of processing units having received a signal indicating that the printing object have been detected from the printing object detection unit; and
a printing unit that controls the plurality of nozzles and performs printing based on the signals for controlling the charges that have been transmitted by the charge control signal transmission unit.

4. The inkjet recording device according to claim 3, further comprising:
a selection unit that selects whether to perform a synchronous printing control that is a control of transmitting the signals for controlling the charges of the plurality of nozzles at a timing when the signals from all of the plurality of processing units are received or to perform an asynchronous printing control that is a control of transmitting the signals for controlling the charges of the plurality of nozzles at a timing when the signals are received from any one of the plurality of processing units.
